(19) United States
(12) Patent Application Publication
(10) Pub. No.: US 2005/0167285 A1
(43) Pub. Date: Aug. 4, 2005

(54) Electrochemical method for the removal of arsenate from drinking water

(75) Inventors: S. Pushpavanam, Tamil Nadu (IN); G. Sozhan, Tamil Nadu (IN); S. Mohan, Tamil Nadu (IN); S. Vasudevan, Tamil Nadu (IN)

Correspondence Address: NIXON & VANDERHYE, PC, 901 NORTH GLEBE ROAD, 11TH FLOOR, ARLINGTON, VA, 22203, US

(73) Assignee: Council of Scientific and Industrial Research, New Delhi (IN)

(21) Appl. No.: 11/019,943

(22) Filed: Dec. 23, 2004

(30) Foreign Application Priority Data
Jan. 30, 2004 (IN) 151/DEL/2004

(51) Int. Cl. C02F 1/461

(52) U.S. Cl. 205/742; 205/761

(57) ABSTRACT

The present invention provides an electrochemical method for the removal of arsenate from drinking water, wherein the arsenate is removed by adsorption of metal hydroxide, formed by ‘in-situ’ anodic oxidation. The electrochemical method, of the present invention, for the removal of arsenate from drinking water, obviates the drawbacks of the commonly used physico-chemical treatments processes such as lime softening, sorption techniques and membrane techniques. The electrochemical method consists of an electrochemical cell fitted with an anode of mild steel or aluminium plate and stainless steel cathode with an inter-electrode distance of 0.5 to 1.5 cm. Drinking water containing 0.5 to 3.0 mg/l of arsenate at a pH in the range of 3-10 and at a temperature between 20-60° C. is electrolysed at anode and cathode current densities between 0.05-0.2 A.dm⁻². The iron hydroxide/aluminium hydroxide formed from the anode during electrolysis adsorbs the arsenate present in the water and settles at the bottom. The removal efficiency of this method is up to 98%.

### FIELD OF THE INVENTION

The present invention relates to an electrochemical method for the removal of arsenate from drinking water.

The process of the present invention will find wide spread usage in arsenate affected areas both in the developing, such as India, Bangladesh, as well as in the developed countries such as United States. It will be particularly useful in areas such as East and North East India. Apart from the above, this method may be utilised by (i) industries handling various ores in non-ferrous metal smelters, (ii) production industries such as glass, pigments, lead-acid battery plates, electronic components and special alloys resistant to corrosion with increased hardness.

### BACKGROUND OF THE INVENTION

The hitherto commonly used physico-chemical treatment processes are lime softening, sorption techniques such as ion-exchange, activated alumina, iron coated sand and membrane techniques such as reverse osmosis, nano-filtration and electrodialysis.

Literature references include:
1. R. Y. Ning, Desalination, 143 (2002) 237.
2. E. O. Kartinen and C. J. Martin, Desalination, 103 (1995) 79.
3. P. Brandhuber and G. Amy, Desalination, 117 (1998) 1.
4. S. J Hug, L. Canonica, M. Weglin, D. Gechter and U. V Gunten, Environ. Sci. Tech., 35 (2001) 2114
5. O. S. Thirunavukkarasu, T. Viraraghavan and K. S. Subramanian, Water Qual. Res J. Canada, 36 (2001) 55.
   Patent References Include:

U.S. Pat. No. 4,366,128 (1982), titled: Removal of arsenic from aqueous solutions. A process for removing arsenic from an aqueous solution containing arsenic in the form of a soluble arsenate includes adjusting the pH of the solution if necessary to at least about 10, adding a soluble barium salt to precipitate arsenic as barium arsenate, and removing the precipitated barium arsenate from the solution.

U.S. Pat. No. 6,368,510, titled: Method and apparatus for the removal of arsenic from water. A method and apparatus for removing arsenic from water at point of entry or point of use particularly for residential application. The point of entry system comprises a first stage having a manganese greensand oxidizer to convert arsenite (As+3) present in the water to arsenate (As+5) and a second stage for passing the water through an anion exchange resin. Each stage includes a control head for automatic regeneration at a predetermined frequency. Manganese greensand is regenerated with a solution of potassium permanganate and anion exchange resin is regenerated with a salt solution. An alternate embodiment for point of use application comprises a manganese greensand oxidizer cartridge to convert arsenite (As+3) to arsenate (As+5) followed by removal of the arsenate (As+5) with a reverse osmosis system.

PCT Publication WO-03086564, titled: removal of arsenic from drinking and process water. A method of removing arsenic and heavy metals from water using metal salt hydroxidegels is provided. The arsenic present in water is adsorbed onto the hydroxide-gels which can effectively be filtered through a diatomaceous earth (DE) filtration bed. The combination of DE mixed hydroxide-gels is also effective in removing arsenic from water and heavy metals from water.

Japanese Patent JP2002079015 S, a filter for removing arsenic from groundwater, especially a filter for removing arsenic which is reusable and for efficient water filtration at a pH of usual drinking water. The filter for arsenic removal is composed of fired diatomaceous earth and 5-30% by weight of ferric ion bonded to the fired diatomaceous earth. One production method of the filter for arsenic removal comprises steps of mixing fired diatomaceous earth and a ferric chloride, keeping the mixture for a long period so as to impregnate the diatomaceous earth with all of the ferric chloride, adding sodium hydroxide to the resulting mixture until the pH of the mixture reaches at least 9.0, gradually and completely oxidizing ferric chloride to ferric hydroxide. The filter for arsenic removal obtained in such a manner has firm and durable bonds between the ferric ion and the fired diatomaceous earth. The filter for arsenic removal can be regenerated several times and the decrease of the arsenic adsorption capability is suppressed to the minimum. The regeneration method of the filter for arsenic removal comprises steps of desorbing arsenic using sodium hydroxide and then washing the filter in situ.

U.S. Pat. No. 6,613,230, titled: Method for simultaneous removal of arsenic and fluoride from aqueous solutions. A method of removing arsenic and fluoride from aqueous solutions in the same process is provided. Specifically, the pH of the aqueous solution is adjusted to a pH in the range of about 5 to 8. A combination of calcium salts, and ferric or aluminum salts are added to form insoluble arsenic and fluoride bearing solids. The solids are then removed from the aqueous solution.

The disadvantages of the hitherto known prior art as described herein above are.
i. Lime softening: disposal of waste is an environmental problem.
ii. Sorption technique:
(a) Ion exchange: requires pre-treatment for preventing clogging. Disposal of highly concentrated spent regenerant is a serious problem. Moderately expensive.
(b) Activated alumina: lack of availability of F-I alumina replacement. Regeneration required, may not be efficient in the long term, pre-treatment require for media clogging, produces arsenic rich waste and relatively high cost.
iii. Membrane technique:
(a) Reverse osmosis, (b) Nano-filtration; and (c) Electrodialysis: pre-treatment required, discharge of reject water is very high, high-tech operation and maintenance, very high capital and running cost.

From the survey of the hitherto known prior art, it is observed that there is no reported electrochemical method for the removal of arsenate. More particularly, there is no reported electrochemical method for the removal of arsenate from drinking water

### OBJECTS OF THE INVENTION

The main object of the invention is to provide an electrochemical method for the removal of arsenate from drinking water, which obviates the drawbacks of the hitherto known prior art as detailed above.

Another object of the invention is to employ the iron/aluminium anodes to reduce the cost involved in the process.

Yet another object of the present invention is to provide an electrochemical method which produces treated water with less Total Dissolved Solids (TDS) compared with chemical method.

Another object of the invention is to provide an electrochemical method which requires low maintenance and minimum operator attention.

Yet another object of the invention is to provide an electrochemical method having low operating cost due to low power requirements.

A further object of the invention is to provide an electrochemical method having low sludge formation compared to chemical method.

A further object of the invention is to provide an electrochemical method wherein no chemical addition is required.

Another object of the invention is to provide an electrochemical method which provides a better removal efficiency than chemical treatment.

Another object of the invention is to provide an electrochemical method wherein the electrolytic method by itself does not give rise to any pollution of the water and atmosphere.

### SUMMARY OF THE INVENTION

The present invention provides an electrochemical method for the removal of arsenate from drinking water, wherein the arsenate is removed by adsorption of metal hydroxide, formed by ‘in-situ’ anodic oxidation. Accordingly, the present invention provides an electrochemical method for removal of arsenate from drinking water, which comprises subjecting arsenate contaminated drinking water to electrolysis in an electrochemical cell having at least one anode of a material selected from the group consisting of mild steel and aluminium and at least one cathode of material consisting of stainless steel.

In an embodiment of the invention, the drinking water containing arsenate of the order of 0.5 to 3.0 mg/l is used as an electrolyte.

In another embodiment of the invention, the electrochemical cell has a plurality anodes and cathodes.

In still another embodiment of the invention, the anode(s) and cathode(s) are fabricated in the form of sheets and preferably with an inter-electrode distance of 0.5-1.5 cm.

In yet another embodiment of the invention, the electrolysis is effected at a pH in the range of 3 to 10 and at a temperature in the range of 20 to 60° C.

In a further embodiment of the invention, the electrolysis is effected at an anode current density in the range of 0.05 to 0.2 Adm⁻² and at a cathode current density in the range of 0.05 to 0.2 Adm⁻².

In another embodiment of the present invention, the arsenate contaminated drinking water containing arsenate of the order of 0.5 to 3.0 mg/l is treated to reduce the arsenate contamination to 0.05 mg/l, with a removal efficiency of up to 98% and made fit for drinking.

In another embodiment of the invention, the electrochemical cell is fitted with an anode of mild steel or aluminium plate and a stainless steel cathode with an inter-electrode distance of 0.5 to 1.5 cm, wherein drinking water containing 0.5 to 3.0 mg/l of arsenate at a pH in the range of 3-10 and at a temperature between 20-60° C. is electrolysed at anode and cathode current densities between 0.05-0.2 A.dm⁻²and iron hydroxide/aluminium hydroxide formed from the anode during electrolysis adsorbs the arsenate present in the water and settles at the bottom.

### DETAILED DESCRIPTION OF THE INVENTION

The present invention provides an electrochemical method for the removal of arsenate from drinking water, wherein the arsenate is removed by adsorption of metal hydroxide, formed by ‘in-situ’ anodic oxidation.

The electrochemical method, of the present invention, for the removal of arsenate from drinking water obviates the drawbacks of the commonly used physico-chemical treatment processes such as lime softening, sorption techniques and membrane techniques. The electrochemical method consists of an electrochemical cell fitted with an anode of mild steel or aluminium plate and stainless steel cathode with an inter-electrode distance of 0.5 to 1.5 cm. Drinking water containing 0.5 to 3.0 mg/l of arsenate at a pH in the range of 3-10 and at a temperature between 20-60° C. is electrolysed at anode and cathode current densities between 0.05-0.2 A.dm⁻². The iron hydroxide/aluminium hydroxide formed from the anode during electrolysis adsorbs the arsenate present in the water and settles at the bottom. The removal efficiency of this method is up to 98%.

The present invention provides an electrochemical method for the removal of arsenate from drinking water, which comprises subjecting arsenate contaminated drinking water to electrolysis in an electrochemical cell having anode of material such as mild steel, aluminium and cathode of material such as stainless steel. Drinking water containing arsenate of the order of 0.5 to 3.0 mg/l is used as the electrolyte. The electrochemical cell can have a plurality of anodes and cathodes. The anode(s) and cathode(s) are preferably fabricated in the form of sheet(s) and are placed at an inter-electrode distance of 0.5 to 1.5 cm.

Electrolysis is effected at a pH in the range of 3 to 10 and at a temperature in the range of 20 to 60° C. The current density at the anode during electrolysis is in the range of 0.05 to 0.2 Adm⁻² and at the cathode is in the range of 0.05 to 0.2 Adm⁻².

The arsenate contaminated drinking water containing arsenate of the order of 0.5 to 3.0 mg/l is effectively treated, by the method described herein above, to reduce the arsenate contamination to 0.05 mg/l, with a removal efficiency of up to 98% and made fit for drinking

The novelty of the present invention, resides in providing a simple, single step electrochemical method without the addition of external chemicals, for the removal of arsenate from drinking water. This method is capable of effectively reducing the arsenate concentration from drinking water to 0.05 mg/l from the initial concentration of 3.0 mg/l, with a removal efficiency of up to 98%. The novelty of the present invention, of effective removal of arsenate from drinking water is achieved by the non-obvious inventive step essentially consisting of the formation of metal hydroxide by anodic dissolution. When anode is oxidised, hydroxide is formed, this in-situ metal hydroxide adsorbs the arsenate present in the water and settles at the bottom of the electrochemical cell. The non-obvious inventive step of in-situ generation of electro-coagulant in the electrolytic cell is effective in the removal of arsenate from drinking water and imparts the novelty to the invented method, to reduce the arsenate contamination to 0.05 mg/l with a removal efficiency of up to 98%. Hitherto arsenate has been removed by different physico-chemical techniques, such as chemical coagulation, reverse osmosis, electrodialysis, nanofiltration. The electrochemical method to remove arsenate by in-situ generated electro-coagulant are not present in the hitherto known prior art processes.

The following examples illustrate the electrochemical method of the present invention for the removal of arsenate from drinking water in actual practice and should not be construed to limit the scope of this invention.

### EXAMPLE 1 TO EXAMPLE 9

Example 1 to example 9 are given in the following Table. The various operating conditions for each of the examples, such as electrolyte volume, temperature, current density, cell voltage and the arsenate removal efficiency are detailed. The anode used is mild steel (MS) or Aluminium (Al) and the cathode used is stainless steel (SS).

| S. No. | Operating canditions | 1 | 2 | 3 | 4 | 5 | 6 | 7 | 8 | 9 |
|---|---|---|---|---|---|---|---|---|---|---|
| 1. | Electrolyte volume | 240 | 240 | 240 | 240 | 240 | 240 | 240 | 240 | 240 |
| | (ml) | | | | | | | | | |
| | Initial conc. of | 3.00 | 3.00 | 3.00 | 3.00 | 3.00 | 0.50 | 3.00 | 3.00 | 3.00 |
| | arsenate (mg/l) | | | | | | | | | |
| | Final conc. of | 0.05 | 0.23 | 1.76 | 1.00 | 0.91 | 0.03 | 2.15 | 0.51 | 0.30 |
| | arsenate (mg/l) | | | | | | | | | |
| | PH | 7.00 | 7.00 | 7.00 | 7.00 | 7.00 | 7.00 | 10.0 | 3.00 | 7.00 |
| | Temperature (° C.) | 32.0 | 32.0 | 32.0 | 20.0 | 32.0 | 32.0 | 32.0 | 32.0 | 60.0 |
| 2. | Anode material | MS | MS | Al | MS | MS | MS | MS | MS | MS |
| 3. | Anode current density | 0.1 | 0.2 | 0.1 | 0.1 | 0.05 | 0.1 | 0.1 | 0.1 | 0.1 |
| | (A · dm⁻²) | | | | | | | | | |
| 4. | Cathode material | SS | SS | SS | SS | SS | SS | SS | SS | SS |
| 5. | Cathode current | 0.1 | 0.2 | 0.1 | 0.1 | 0.05 | 0.1 | 0.1 | 0.1 | 0.1 |
| | density (A · dm⁻²) | | | | | | | | | |
| 6. | Current passed (mA) | 40 | 40 | 40 | 40 | 40 | 40 | 40 | 40 | 40 |
| 7. | Total qty. of | 32 | 32 | 32 | 32 | 32 | 32 | 32 | 32 | 32 |
| | electricity | | | | | | | | | |
| | Passed (mAh) | | | | | | | | | |
| 8. | Cell voltage (V) | 1.7 | 1.8 | 1.8 | 2.2 | 1.0 | 1.7 | 1.7 | 1.7 | 1.7 |
| 9. | Removal efficiency | 98 | 92 | 41 | 67 | 70 | 94 | 28 | 83 | 90 |
| | (%) | | | | | | | | | |

The main advantages of the electrochemical method, of the present invention, for the removal of arsenate from drinking water, are
1. Produces treated water with less Total Dissolved Solids (TDS) as compared with chemical method.
2. Requires low maintenance and minimum operator attention.
3. Gas bubbles evolved in the electrochemical cell help to carry the pollutants to the to of the solution so that they can be easily removed.
4. Less operating cost due to low power requirements.
5. Low sludge formation compared to chemical method.
6. No chemical addition is required.
7. All the materials used in this method are easily available.
8. Provides a better removal efficiency than chemical treatment.
9. Does not give rise to any pollution of the water and atmosphere.
10. Cost effective and highly competitive method when compared to other physico-chemical methods.

1. An electrochemical method for removal of arsenate from drinking water, which comprises subjecting arsenate contaminated drinking water to electrolysis in an electrochemical cell having at least one anode of a material selected from the group consisting of mild steel and aluminium and at least one cathode of material consisting of stainless steel.

2. A method as claimed in claim 1 wherein the drinking water containing arsenate of the order of 0.5 to 3.0 mg/l is used as an electrolyte.

3. A method as claimed in claim 1 wherein the electrochemical cell has a plurality anodes and cathodes

4. A method as claimed in claim 1 wherein the anode(s) and cathode(s) are in the form of sheets).

5. A method as claimed in claim 1 wherein the anode(s) and cathode(s) are placed at an inter-electrode distance of 0.5 to 1.5 cm.

6. A method as claimed in claim 1 wherein the electrolysis is effected at a pH in the range of 3 to 10.

7. A method as claimed in claim 1 wherein the electrolysis is effected at a temperature in the range of 20 to 60° C.

8. A method as claimed in claim 1 wherein the electrolysis is effected at an anode current density in the range of 0.05 to 0.2 Adm⁻².

9. A method as claimed in claim 1 wherein the electrolysis is effected at cathode current density in the range of 0.05 to 0.2 Adm⁻².

10. A method as claimed in claim 1 wherein the arsenate contaminated drinking water containing arsenate of the order of 0 5 to 3.0 mg/l is treated to reduce the arsenate contamination to 0.05 mg/l, with a removal efficiency of up to 98% and made fit for drinking.

11. A method as claimed in claim 1 wherein the electrochemical cell is fitted with an anode of mild steel or aluminium plate and a stainless steel cathode with an inter-electrode distance of 0.5 to 1.5 cm, wherein drinking water containing 0.5 to 3.0 mg/l of arsenate at a pH in the range of 3-10 and at a temperature between 20-60° C. is electrolysed at anode and cathode current densities between 0.05-0.2 A.dm⁻², and iron hydroxide/aluminium hydroxide formed from the anode during electrolysis adsorbs the arsenate present in the water and settles at the bottom.
